(19) United States
(12) Patent Application Publication
(10) Pub. No.: US 2026/0233442 A1
(43) Pub. Date: Aug. 13, 2026

(54) HEAT-EXPANDABLE MICROSPHERES AND USE THEREOF

(71) Applicant: MATSUMOTO YUSHI-SEIYAKU CO., LTD., Yao-shi, Osaka (JP)

(72) Inventor: Tomohiro MESHIZUKA, Yao-shi, Osaka (JP)

(73) Assignee: MATSUMOTO YUSHI-SEIYAKU CO., LTD., Yao-shi, Osaka (JP)

(21) Appl. No.: 19/155,671

(22) PCT Filed: Feb. 21, 2024
(86) PCT No.: PCT/JP2024/006163

§ 371 Date: Aug. 12, 2025

(30) Foreign Application Priority Data
Mar. 8, 2023 (JP) 2023-035400

(51) Int. Cl. B29C 45/00; B29K 33/00; B29K 33/20; C08J 9/18; C08K 5/01

(52) U.S. Cl. CPC B29C 45/0001; C08J 9/18; C08K 5/01; B29K 2033/12; B29K 2033/20; C08J 2333/12; C08J 2335/04

(57) ABSTRACT

Heat-expandable microspheres include: a shell containing a thermoplastic resin; and a blowing agent that is encapsulated in the shell and is vaporized by heating. The thermoplastic resin is a polymer of a polymerizable component containing at least one selected from the group consisting of a carboxyl group-containing monomer, a (meth)acrylic acid ester-based monomer, a styrene-based monomer, and a (meth)acrylamide-based monomer. A recovery efficiency after compression when the heat-expandable microspheres are heated at a temperature lower by 20° C. than a maximum expansion temperature of the heat-expandable microspheres for 2 minutes is greater than 0 and less than or equal to 3.5. A compression recovery rate when the heat-expandable microspheres are heated at the temperature lower by 20° C. than the maximum expansion temperature of the heat-expandable microspheres for 2 minutes is greater than or equal to 65%.

### CROSS-REFERENCE TO RELATED APPLICATIONS

This application is a National Stage of International Application No. PCT/JP2024/006163 filed Feb. 21, 2024, claiming priority from Japanese Patent Application No. 2023-035400 filed Mar. 8, 2023.

### BACKGROUND OF THE INVENTION

### Field of the Invention

The present invention relates to heat-expandable microspheres and use thereof.

### Description of the Related Art

Microspheres having a structure in which a thermoplastic resin is used as a shell and a blowing agent is encapsulated in the shell are generally called heat-expandable microspheres (heat-expandable microcapsules). The heat-expandable microspheres are microspheres having a feature of expanding by applying heat treatment.

The heat-expandable microspheres are used in a wide range of applications, and for example, the heat-expandable microspheres are blended in a base material. By the heat treatment applied during molding, the heat-expandable microspheres expand simultaneously with molding, and not only the weight of a molded article can be reduced, but also designability, cushioning properties, and the like can be imparted to the molded article.

In order to ensure the expansion function of the heat-expandable microspheres, the thermoplastic resin used for the shell thereof usually needs to have a gas barrier property.

As such heat-expandable microspheres, Patent Literature 1 discloses heat-expandable microspheres in which the shell encapsulating a blowing agent comprises a copolymer capable of forming a polymethacrylimide structure. In particular, it discloses a specific example of heat-expandable microspheres in which methacrylonitrile and methacrylic acid are used as monomers capable of forming the polymethacrylimide structure by a copolymerization reaction.

Patent Literature 2 discloses heat-expandable microspheres which contain a methacrylic acid ester-based monomer and a carboxyl group-containing monomer as essential components, in which a nitrile-based monomer is the shell made of a thermoplastic resin obtained by polymerizing a polymerizable component in an amount of 0 to 30 parts by weight based on 100 parts by weight of the total amount of the methacrylic acid ester-based monomer and the carboxyl group-containing monomer, and in which an encapsulated blowing agent contains a hydrocarbon having greater than or equal to 8 carbon atoms as an essential component.

Patent Literature 3 discloses heat-expandable microspheres in which a repeated high temperature pressure resistance, measured at 70° C., of hollow fine particles obtained by thermally expanding heat-expandable microspheres is greater than or equal to 75%, and a retention rate of a blowing agent before and after the heat expansion is greater than or equal to 80%.
Patent Literature 1: WO 2007/072769 A1
Patent Literature 2: WO 2015/178329 A1
Patent Literature 3: JP 2011-195813 A

### Problems to be Solved by the Invention

However, the heat-expandable microspheres disclosed in Patent Literature 1 are excellent in heat resistance, have a high blowing ratio, and exhibit a stable blowing behavior, but it is difficult for a molded article obtained using the heat-expandable microspheres to return to the original shape when the molded article is deformed due to the effect of external pressure. Furthermore, the heat-expandable microspheres described in Patent Literature 2 are substantially spherical, have excellent expandability, and have good workability when mixed with a resin, but have insufficient expansion characteristics, and it is difficult for a molded article obtained using the heat-expandable microspheres to return to the original shape when the molded article is deformed due to the effect of external pressure. In addition, the heat-expandable microspheres disclosed in Patent Literature 3 have a shape close to a sphere, the thickness of a shell of the heat-expandable microspheres is uniform, and the presence of large resin particles on the inner side of the shell is suppressed. However, when a molded article obtained using the heat-expandable microspheres is deformed due to the effect of external pressure, it is difficult for the heat-expandable microspheres to return to the original shape.

### SUMMARY OF THE INVENTION

An object of the present invention is to provide heat-expandable microspheres capable of yielding a molded article that is hardly deformed for a long period of time, and use thereof.

As a result of intensive studies, the present inventors have found that the above-described problems can be solved when heat-expandable microspheres include a shell containing a specific thermoplastic resin and a blowing agent encapsulated in the shell, and exhibit specific physical properties, and have reached the present invention.

That is, the present invention is heat-expandable microspheres including: a shell containing a thermoplastic resin; and a blowing agent that is encapsulated in the shell and is vaporized by heating, in which the thermoplastic resin is a polymer of a polymerizable component containing at least one selected from the group consisting of a carboxyl group-containing monomer, a (meth)acrylic acid ester-based monomer, a styrene-based monomer, and a (meth)acrylamide-based monomer, a recovery efficiency after compression when the heat-expandable microspheres are heated at a temperature lower by 20° C. than a maximum expansion temperature of the heat-expandable microspheres for 2 minutes is greater than 0 and less than or equal to 3.5, and a compression recovery rate when the heat-expandable microspheres are heated at the temperature lower by 20° C. than the maximum expansion temperature of the heat-expandable microspheres for 2 minutes is greater than or equal to 65%.

The heat-expandable microspheres of the present invention preferably satisfy at least one of the following 1) to 4).
1) The polymerizable component contains the carboxyl group-containing monomer, and contains at least one selected from the group consisting of the (meth)acrylic acid ester-based monomer, the styrene-based monomer, and the (meth)acrylamide-based monomer.
2) The weight ratio of the carboxyl group-containing monomer to the polymerizable component is 10 to 80 wt %, and the weight ratio of at least one selected from the group consisting of the (meth)acrylic acid ester-based monomer, the styrene-based monomer, and the (meth)acrylamide-based monomer to the polymerizable component is 10 to 77 wt %.
3) The blowing agent contains greater than or equal to 70 wt % of a hydrocarbon having 5 to 6 carbon atoms.
4) The weight ratio of acrylonitrile to the polymerizable component is less than or equal to 13 wt %.

Hollow particles of the present invention are an expanded product of the heat-expandable microspheres.

Fine-particle-coated hollow particles of the present invention include the hollow particles and fine particles coating an outer surface of a shell portion of the hollow particles.

A composition of the present invention contains at least one selected from the group consisting of the heat-expandable microspheres, the hollow particles, and the fine-particle-coated hollow particles, and a base material component.

A molded article of the present invention is obtained by molding the composition.

### Advantageous Effects of the Invention

The heat-expandable microspheres of the present invention are capable of yielding a molded article that is hardly deformed for a long period of time.

The hollow particles of the present invention are lightweight and are excellent in recoverability.

The fine-particle-coated hollow particles of the present invention include the hollow particles and the fine particles coating the outer surface of the shell portion of the hollow particles, are lightweight, and are excellent in recoverability.

The composition of the present invention contains at least one selected from the group consisting of the heat-expandable microspheres, the hollow particles, and the fine-particle-coated hollow particles, and the base material component, and is capable of yielding a molded article that is lightweight and is hardly deformed for a long period of time.

The molded article of the present invention is obtained by molding the composition, is lightweight, and is hardly deformed for a long period of time.

### BRIEF DESCRIPTION OF THE DRAWINGS

FIG. 1 is a schematic diagram illustrating an example of heat-expandable microspheres.

FIG. 2 is a schematic diagram illustrating an example of fine-particle-coated hollow particles.

### REFERENCE NUMBERS LIST

Reference numbers used to identify various features in the drawings include the following:
1 Fine-particle-coated hollow particles
2 Shell portion
3 Hollow portion
4 Fine particles (adsorbed state)
5 Fine particles (embedded and fixed state)
6 Shell
7 Blowing agent (core)

### DETAILED DESCRIPTION OF PREFERRED EMBODIMENTS

The heat-expandable microspheres of the present invention are specifically described as follows. However, the present invention should not be construed as being limited thereto.

### [Heat-Expandable Microspheres]

Heat-expandable microspheres of the present invention include a shell containing a thermoplastic resin, and a blowing agent that is encapsulated in the shell and is vaporized by heating, and the heat-expandable microspheres exhibit heat expandability as a whole (a property that the microspheres expand as a whole by heating).

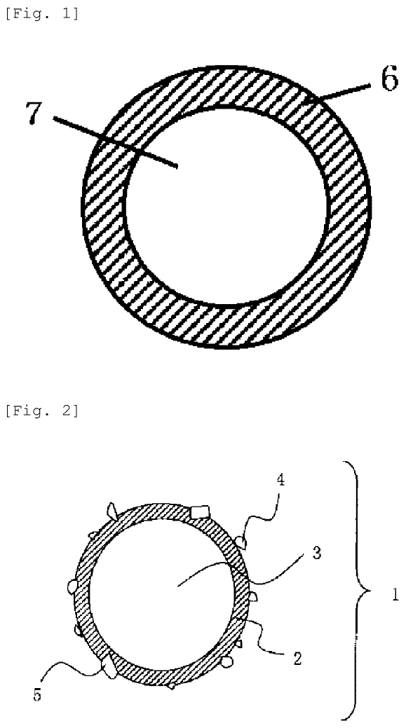

As illustrated in FIG. 1, the heat-expandable microspheres of the present invention each have a core-shell structure composed of a shell 6 and a blowing agent (core) 7.

In the heat-expandable microspheres of the present invention, the thermoplastic resin forming the shell is a polymer of a polymerizable component. The polymerizable component contains a monomer having one (radical) polymerizable carbon-carbon double bond, and the monomer having one (radical) polymerizable carbon-carbon double bond is a component capable of an addition reaction.

The polymerizable component contains at least one selected from the group consisting of a carboxyl group-containing monomer, a (meth)acrylic acid ester-based monomer, a styrene-based monomer, and a (meth)acrylamide-based monomer. The carboxyl group-containing monomer, the (meth)acrylic acid ester-based monomer, the styrene-based monomer, and the (meth)acrylamide-based monomer contain a monomer having one (radical) polymerizable carbon-carbon double bond.

Furthermore, in the heat-expandable microspheres of the present invention, the recovery efficiency after compression when the heat-expandable microspheres are heated at a temperature lower by 20° C. than the maximum expansion temperature of the heat-expandable microspheres for 2 minutes is greater than 0 and less than or equal to 3.5, and the compression recovery rate when the heat-expandable microspheres are heated at the temperature lower by 20° C. than the maximum expansion temperature for 2 minutes is greater than or equal to 65%.

The heat-expandable microspheres include the shell having high heat resistance and flexibility, and an obtained expanded product can have a high pressure from the inside, so that it is considered that deformation due to an external force is suppressed or the expanded product quickly recovers even if the expanded product is deformed, and a molded article that is hardly deformed for a long period of time can be obtained.

The carboxyl group-containing monomer is not particularly limited, and examples of the carboxyl group-containing monomer include unsaturated monocarboxylic acids such as acrylic acid, methacrylic acid, ethacrylic acid, crotonic acid, and cinnamic acid; unsaturated dicarboxylic acids such as maleic acid, itaconic acid, fumaric acid, citraconic acid, and chloromaleic acid; anhydrides of unsaturated dicarboxylic acids; and unsaturated dicarboxylic acid monoesters such as monomethyl maleate, monoethyl maleate, monobutyl maleate, monomethyl fumarate, monoethyl fumarate, monomethyl itaconate, monoethyl itaconate, and monobutyl itaconate, and these monomers may be used alone or in combination of two or more thereof. In addition, some or all of carboxyl groups of the monomer may be neutralized during or after polymerization, or may be in a salt state.

The (meth)acrylic acid ester-based monomer is not particularly limited, and examples of the (meth)acrylic acid ester monomer include methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate, and 2-hydroxyethyl (meth)acrylate, and these monomers may be used alone or in combination of two or more thereof.

In the present invention, acrylic acid or methacrylic acid may be collectively referred to as (meth)acrylic acid. In the present invention, (meth)acrylate means acrylate or methacrylate, and (meth)acryl means acryl or methacryl.

The styrene-based monomer is not particularly limited, and examples of the styrene-based monomer include styrene, α-methylstyrene, styrenesulfonic acid and a salt thereof, and these styrene-based monomers may be used alone or in combination of two or more thereof.

Examples of the (meth)acrylamide-based monomer include acrylamide, substituted acrylamide, methacrylamide, and substituted methacrylamide, and these monomers may be used alone or in combination of two or more thereof.

The total weight ratio of the carboxyl group-containing monomer, the (meth)acrylic acid ester-based monomer, the styrene-based monomer, and the (meth)acrylamide-based monomer to the polymerizable component is not particularly limited, but is preferably 20 to 100 wt %. When the weight ratio is in the above-described range, the heat resistance of the shell is improved, and the shell tends to have good flexibility. Furthermore, yellowing at the time of heating tends to be reduced. The upper limit of the weight ratio is more preferably 99.99 wt % and still more preferably 99.98 wt %. On the other hand, the lower limit of the weight ratio is more preferably 25 wt % and still more preferably 30 wt %. The weight ratio is more preferably 25 to 99.99 wt %, and still more preferably 30 to 99.98 wt %, for example.

When the polymerizable component contains a carboxyl group-containing monomer, the weight ratio of the carboxyl group-containing monomer to the polymerizable component is not particularly limited, but is preferably 10 to 80 wt %. When the weight ratio is greater than or equal to 10 wt %, the heat resistance of the shell tends to be improved and the recoverability tends to be improved. On the other hand, when the weight ratio is less than or equal to 80 wt %, the rigidity of the shell is not too high and tends to be in an appropriate state. The upper limit of the weight ratio is more preferably 75 wt %, still more preferably 70 wt %, particularly preferably 65 wt %, and most preferably 60 wt %. On the other hand, the lower limit of the weight ratio is more preferably 14 wt %, and still more preferably 18 wt %. The weight ratio is more preferably 14 to 70 wt %, and still more preferably 18 to 65 wt %, for example.

The polymerizable component is not particularly limited, but when the polymerizable component contains a carboxyl group-containing monomer, and further contains at least one selected from the group consisting of a (meth)acrylic acid ester-based monomer, a styrene-based monomer, and a (meth)acrylamide-based monomer, it is preferable from the viewpoint of improving the heat resistance and improving the recoverability of the expanded product obtained, and it is also preferable from the viewpoint of reducing yellowing at the time of heating.

When the polymerizable component contains a carboxyl group-containing monomer and contains at least one selected from the group consisting of a (meth)acrylic acid ester-based monomer, a styrene-based monomer, and (meth)acrylamide, the weight ratio of at least one selected from the group consisting of the (meth)acrylic acid ester-based monomer, the styrene-based monomer, and the (meth)acrylamide is preferably 10 to 77 wt %. When the weight ratio is greater than or equal to 10 wt, the heat resistance of the shell tends to be improved and the recoverability tends to be improved. In addition, yellowing at the time of heating tends to be reduced. On the other hand, when the weight ratio is less than or equal to 77 wt %, the rigidity of the shell is not too high and tends to be in an appropriate state. The upper limit of the weight ratio is more preferably 65 wt %, still more preferably 55 wt %, and particularly preferably 45 wt %. On the other hand, the lower limit of the weight ratio is more preferably 12 wt %, and still more preferably 14 wt %. The weight ratio is more preferably 12 to 70 wt %, and still more preferably 14 to 65 wt %, for example.

The weight ratio of acrylonitrile to the polymerizable component is not particularly limited, but is preferably less than or equal to 13 wt %. When the weight ratio is less than or equal to 13 wt %, the rigidity of the shell is in an appropriate state, and the recoverability of the obtained expanded product against an external force tends to be improved. In addition, yellowing at the time of heating tends to be reduced. The upper limit of the weight ratio is more preferably 10 wt %, still more preferably 7 wt %, and particularly preferably 5 wt %. On the other hand, the lower limit of the weight ratio is preferably 0 wt %. The weight ratio is more preferably 0 to 10 wt %, and still more preferably 0 to 7 wt %, for example.

The polymerizable component may contain a monomer (hereinafter, may be simply referred to as the other monomer) having one (radical) polymerizable carbon-carbon double bond, in addition to the acrylonitrile, the carboxyl group-containing monomer, the (meth)acrylic acid ester-based monomer, the styrene-based monomer, and the (meth)acrylamide-based monomer.

Examples of the other monomer component include nitrile-based monomers other than acrylonitrile such as methacrylonitrile, fumaronitrile, and maleonitrile; vinyl halide-based monomer such as vinyl chloride; vinylidene halide-based monomer such as vinylidene chloride; vinyl ester-based monomers such as vinyl acetate, vinyl propionate, and vinyl butyrate; ethylenically unsaturated monoolefin-based monomer such as ethylene, propylene, and isobutylene; vinyl ether-based monomer such as vinyl methyl ether, vinyl ethyl ether, and vinyl isobutyl ether; vinyl ketone-based monomer such as vinyl methyl ketone; N-vinyl-based monomer such as N-vinylcarbazole and N-vinylpyrrolidone; vinylnaphthalene salts, and the like. These other monomer components may be used alone or in combination of two or more thereof.

The polymerizable component is not particularly limited, but may contain methacrylonitrile. It is preferable that the polymerizable component contain methacrylonitrile from the viewpoint of improving the gas barrier property of the shell and improving the expansion performance.

The weight ratio of methacrylonitrile to the polymerizable component is not particularly limited, but is preferably 0 to 70 wt %. The upper limit of the weight ratio is more preferably 65 wt %, still more preferably 60 wt %, and particularly preferably 55 wt %. On the other hand, the lower limit of the weight ratio is more preferably 5 wt %, still more preferably 10 wt %, and particularly preferably 15 wt %. The weight ratio is more preferably 0 to 65 wt %, and still more preferably 5 to 60 wt %, for example.

The polymerizable component may contain a monomer (hereinafter, may be simply referred to as a crosslinking agent) having at least two (radical) polymerizable carbon-carbon double bonds, in addition to the monomer having one (radical) polymerizable carbon-carbon double bond. The crosslinking agent is also a component capable of an addition reaction, the obtained thermoplastic resin can have a crosslinked structure, and the obtained heat-expandable microspheres tend to suppress a decrease in the retention rate (encapsulation retention rate) of the encapsulated blowing agent at the time of heat expansion.

Examples of the crosslinking agent include aromatic divinyl compounds such as divinylbenzene; and polyfunctional (meth)acrylate compounds such as allyl methacrylate, triacrylic formal, triallyl isocyanate, ethylene glycol di(meth)acrylate, diethylene glycol di(meth)acrylate, triethylene glycol di(meth)acrylate, neopentyl glycol di(meth)acrylate, polytetramethylene glycol diacrylate, 1,4-butanediol di(meth)acrylate, 1,6-hexanediol di(meth)acrylate, 1,9-nonanediol di(meth)acrylate, PEG #200 di(meth)acrylate, PEG #400 di(meth)acrylate, PEG #600 di(meth)acrylate, trimethylolpropane tri(meth)acrylate, pentaerythritol tri(meth)acrylate, pentaerythritol tetraacrylate, dipentaerythritol hexaacrylate, 2-butyl-2-ethyl-1,3-propanediol diacrylate, and tricyclodecane dimethanol di(meth)acrylate, and these crosslinking agents may be used alone or in combination of two or more thereof.

The polymerizable component may not contain a crosslinking agent, but the amount of the crosslinking agent is not particularly limited, and is preferably 0 to 4 wt %, more preferably 0.01 to 2 wt %, still more preferably 0.02 to 1 wt %, and particularly preferably 0.05 to 0.5 wt %, based on 100 wt % of the polymerizable component.

The blowing agent contained in the heat-expandable microspheres of the present invention is a component that is vaporized by heating. Since the blowing agent is encapsulated in the shell constituting the heat-expandable microspheres, the heat-expandable microspheres exhibit heat expandability (property that the microspheres expand as a whole by heating) as the entire microspheres.

The blowing agent is not particularly limited, and examples of the blowing agent include hydrocarbons such as propane, butane, isobutane, n-pentane, 2-methylbutane, 2,2-dimethylpropane, cyclopentane, n-hexane, 2-methylpentane, 3-methylpentane, 2,2-dimethylbutane, 2,3-dimethylbutane, heptane, isoheptane, octane, isooctane, nonane, isononane, decane, isodecane, dodecane, isododecane, tridecane, isotridecane, 4-methyldodecane, tetradecane, isotetradecane, pentadecane, isopentadecane, hexadecane, isohexadecane, 2,2,4,4,6,8,8-heptamethylnonane, heptadecane, isoheptadecane, octadecane, isooctadecane, nanodecane, isodecane, 2,6,10,14-tetramethylpentadecane, cyclododecane, cyclotridecane, hexylcyclohexane, heptylcyclohexane, n-octylcyclohexane, cyclopentadecane, nonylcyclohexane, decylcyclohexane, pentadecylcyclohexane, hexadecylcyclohexane, heptadecylcyclohexane, and octadecylcyclohexane; fluorine-containing compounds such as hydrofluoroether; tetraalkylsilane; and compounds which are thermally decomposed by heating to produce a gas, and one kind or two or more kinds thereof may be used in combination.

The blowing agent may be a linear, branched, or alicyclic compound, and is preferably an aliphatic compound.

The blowing agent is not particularly limited, but when the blowing agent contains a hydrocarbon having 5 to 6 carbon atoms, it is preferable from the viewpoint of being balanced with the heat resistance of the shell and improving the recoverability when the obtained expanded product is deformed.

When the blowing agent contains a hydrocarbon having 5 to 6 carbon atoms, the weight ratio of the hydrocarbon having 5 to 6 carbon atoms to the blowing agent is not particularly limited, but is preferably greater than or equal to 70 wt %. The lower limit of the weight ratio is more preferably greater than or equal to 75 wt %, still more preferably greater than 80 wt %, particularly preferably greater than 85 wt %, and most preferably greater than or equal to 90 wt %. On the other hand, the upper limit of the weight ratio is preferably 100 wt %. The blowing agent may be composed of only a hydrocarbon having 5 to 6 carbon atoms.

When the blowing agent contains a hydrocarbon having 5 carbon atoms or a hydrocarbon having 6 carbon atoms, the weight ratio of the hydrocarbon having 5 carbon atoms or the hydrocarbon having 6 carbon atoms to the blowing agent is preferably within the above-described range.

When the blowing agent contains a hydrocarbon having 5 carbon atoms and a hydrocarbon having 6 carbon atoms, the weight ratio of the hydrocarbon having 5 carbon atoms to the hydrocarbon having 6 carbon atoms (the hydrocarbon having 5 carbon atoms/the hydrocarbon having 6 carbon atoms) is not particularly limited, but is preferably 55/45 to 90/10. When the weight ratio is in the above-described range, a good balance with the heat resistance of the shell can be achieved, and the expansion performance tends to be improved. The upper limit of the weight ratio is more preferably 85/15 and still more preferably 80/20. On the other hand, the lower limit of the weight ratio is more preferably 58/42 and still more preferably 60/40. The weight ratio is, for example, more preferably 58/42 to 85/15, and still more preferably 60/40 to 80/20.

The content of the blowing agent encapsulated in the heat-expandable microspheres of the present invention is defined as the percentage of the weight of the blowing agent contained in the heat-expandable microspheres relative to the weight of the heat-expandable microspheres.

The content is not particularly limited, but is preferably 5 to 50 wt %. When the content is greater than or equal to 5 wt %, the expansion performance of the heat-expandable microspheres tends to be improved. On the other hand, when the content is less than or equal to 50 wt %, the heat resistance tends to be improved. The upper limit of the content is more preferably 40 wt %, still more preferably 35 wt %, and particularly preferably 30 wt %. On the other hand, the lower limit of the content is more preferably 7 wt % and still more preferably 10 wt %. The content is more preferably 7 to 40 wt %, and still more preferably 10 to 30 wt %, for example.

As described above, in the heat-expandable microspheres of the present invention, the recovery efficiency after compression when the heat-expandable microspheres are heated at the temperature lower by 20° C. than the maximum expansion temperature of the heat-expandable microspheres for 2 minutes is greater than 0 and less than or equal to 3.5, and the compression recovery rate when the heat-expandable microspheres are heated at the temperature lower by 20° C. than the maximum expansion temperature for 2 minutes is greater than or equal to 65%.

If the heat-expandable microspheres of the present invention do not satisfy the recovery efficiency and the compression recovery rate, the obtained expanded product, which is a treated article, is deformed by an external force.

In the heat-expandable microspheres of the present invention, the recovery efficiency after compression of the treated article obtained when the heat-expandable microspheres are heated at the temperature lower by 20° C. than the maximum expansion temperature for 2 minutes is preferably 3.1, more preferably 2.7, and still more preferably 2.4. On the other hand, the lower limit of the recovery efficiency is preferably 0.5 and more preferably 1.0. In addition, the recovery efficiency is, for example, preferably 0.5 to 3.1, and more preferably 1.0 to 2.7.

Note that the recovery efficiency after compression when the heat-expandable microspheres are heated at the temperature lower by 20° C. than the maximum expansion temperature of the heat-expandable microspheres for 2 minutes is measured by a method in Examples, and the unit thereof is MPa/mm.

In the heat-expandable microspheres of the present invention, the compression recovery rate of the treated article obtained when the heat-expandable microspheres are heated at the temperature lower by 20° C. than the maximum expansion temperature for 2 minutes is preferably 70 to 100%, and more preferably 75 to 100%.

Note that the compression recovery rate when the heat-expandable microspheres are heated at the temperature lower by 20° C. than the maximum expansion temperature of the heat-expandable microspheres for 2 minutes is measured by a method in Examples.

The expansion-starting temperature (Ts) of the heat-expandable microspheres of the present invention is not particularly limited, but is preferably 100 to 200° C. When the expansion-starting temperature is higher than or equal to 100° C., the heat resistance tends to be improved. On the other hand, when the expansion-starting temperature is lower than or equal to 200° C., the expansion performance tends to be improved. The upper limit of the expansion-starting temperature is more preferably 190° C., still more preferably 180° C., particularly preferably 170° C., and most preferably 160° C. On the other hand, the lower limit of the expansion-starting temperature is more preferably 110° C., still more preferably 120° C., and particularly preferably 130° C. The expansion-starting temperature is, for example, more preferably 110 to 180° C., and still more preferably 130 to 170° C.

The maximum expansion temperature (Tmax) of the heat-expandable microspheres of the present invention is not particularly limited, but is preferably 140 to 300° C. When the maximum expansion temperature is higher than or equal to 140° C., the heat resistance tends to be sufficient. On the other hand, when the maximum expansion temperature is lower than or equal to 300° C., the expansion performance tends to be improved. The upper limit of the maximum expansion temperature is more preferably 250° C., still more preferably 220° C., and particularly preferably 210° C. On the other hand, the lower limit of the maximum expansion temperature is more preferably 150° C. and still more preferably 160° C. The maximum expansion temperature is, for example, more preferably 150 to 250° C., and still more preferably 160 to 210° C.

Note that the expansion-starting temperature (Ts) and the maximum expansion temperature (Tmax) of the heat-expandable microspheres are measured by methods in Examples.

The mean particle size of the heat-expandable microspheres of the present invention is not particularly limited, but is preferably 1 to 200 μm. When the mean particle size is greater than or equal to 1 μm, the expansion performance of the heat-expandable microspheres tends to be improved. On the other hand, when the mean particle size is less than or equal to 200 μm, the heat resistance tends to be improved. The upper limit of the mean particle size is more preferably 80 μm, still more preferably 50 μm, and particularly preferably 40 μm. On the other hand, the lower limit of the mean particle size is more preferably 5 μm and still more preferably 10 μm. The mean particle size is, for example, more preferably 5 to 80 μm, and still more preferably 10 to 50 μm.

Note that the mean particle size of the heat-expandable microspheres is measured by a method in Examples.

The coefficient CV of variation of the particle size distribution of the heat-expandable microspheres of the present invention is not particularly limited, but is preferably less than or equal to 50%, more preferably less than or equal to 40%, still more preferably less than or equal to 35%, and particularly preferably less than or equal to 30%. The coefficient CV of variation of the particle size distribution of the heat-expandable microspheres is calculated by the following calculation formulas (1) and (2).

$$[ Mathematical Formula 1 ]$$

$$CV = ( s / < x > ) \times 100 ( \% ) \qquad ( 1 )$$

$$s = {\{ {\sum }_{i = 1}^{n} {( {x}_{i} - < x > )}^{2} / ( n - 1 ) \}}^{1 / 2} \qquad ( 2 )$$

where s is the standard deviation of the particle size, <x> is the mean particle size, xᵢ is the i-th particle size, and n is the number of particles.

The maximum expansion ratio of the heat-expandable microspheres of the present invention is not particularly limited, but is preferably greater than or equal to 10 times, more preferably greater than or equal to 15 times, still more preferably greater than or equal to 20 times, particularly preferably greater than or equal to 30 times, and still more preferably greater than or equal to 50 times. On the other hand, the upper limit value of the maximum expansion ratio is preferably 300 times.

### [Method for Producing Heat-Expandable Microspheres]

A method for producing the heat-expandable microspheres of the present invention is preferably a method including a step (hereinafter, may be simply referred to as a polymerization step) of dispersing an oily mixture containing a polymerizable component, a blowing agent, and a polymerization initiator in an aqueous dispersion medium to polymerize the polymerizable component.

The polymerization initiator is not particularly limited, and examples of the polymerization initiator include a peroxide and an azo compound.

Examples of the peroxide include peroxydicarbonates such as diisopropyl peroxydicarbonate, di-sec-butyl peroxydicarbonate, di-2-ethylhexyl peroxydicarbonate, and dibenzyl peroxydicarbonate; diacyl peroxides such as dilauroyl peroxide and dibenzoyl peroxide; ketone peroxides such as methyl ethyl ketone peroxide and cyclohexanone peroxide; peroxyketals such as 2,2-bis(t-butylperoxy) butane; hydroperoxides such as cumene hydroperoxide and t-butyl hydroperoxide; dialkyl peroxides such as dicumyl peroxide and di-t-butyl peroxide; and peroxyesters such as t-hexylperoxypivalate and t-butylperoxyisobutyrate.

Examples of the azo compound include 2,2′-azobis(4-methoxy-2,4-dimethylvaleronitrile), 2,2′-azobisisobutyronitrile, 2,2′-azobis(2,4-dimethylvaleronitrile), 2,2′-azobis(2-methylpropionate), 2,2′-azobis(2-methylbutyronitrile), and 1,1′-azobis(cyclohexane-1-carbonitrile).

The amount of the polymerization initiator is not particularly limited, but is preferably 0.05 to 15 parts by weight, more preferably 0.1 to 10 parts by weight, and most preferably 0.3 to 5 parts by weight, based on 100 parts by weight of the polymerizable component. When the amount used is within the above-described range, the heat resistance and expansion performance of the heat-expandable microspheres obtained tend to be improved.

In the polymerization step, the aqueous dispersion medium is a medium for dispersing the oily mixture essentially containing the polymerizable component and the blowing agent, and contains water such as deionized water as a main component. The aqueous dispersion medium may further contain an alcohol such as methanol, ethanol, or propanol, or a hydrophilic organic solvent such as acetone. The hydrophilicity in the present invention means a state of being arbitrarily miscible in water. The amount of the aqueous dispersion medium used is not particularly limited, but it is preferable to use 100 to 1,000 parts by weight of the aqueous dispersion medium based on 100 parts by weight of the polymerizable component.

The aqueous dispersion medium may further contain an electrolyte. Examples of the electrolyte include sodium chloride, magnesium chloride, calcium chloride, sodium sulfate, magnesium sulfate, ammonium sulfate, and sodium carbonate. These electrolytes may be used alone or in combination of two or more thereof.

When the electrolyte is used, the amount of the electrolyte is not particularly limited, but is preferably 0.1 to 50 parts by weight based on 100 parts by weight of the aqueous dispersion medium.

The aqueous dispersion medium may contain at least one water-soluble compound selected from the group consisting of polyalkyleneimines having a structure in which an alkyl group substituted with a hydrophilic functional group selected from a carboxylic acid (salt) group and a phosphonic acid (salt) group is bonded to a nitrogen atom, water-soluble 1,1-substituted compounds having a structure in which a hydrophilic functional group selected from a hydroxyl group, a carboxylic acid (salt) group and a phosphonic acid (salt) group and a hetero atom are bonded to the same carbon atom, potassium dichromate, an alkali metal nitrite, a metal (III) halide, boric acid, water-soluble ascorbic acids, water-soluble polyphenols, water-soluble vitamins B, and water-soluble phosphonic acids (salts).

The term “water-soluble” in the present invention means a state in which 1 g or more is dissolved per 100 g of water.

The amount of the water-soluble compound contained in the aqueous dispersion medium is not particularly limited, but is preferably 0.0001 to 1.0 parts by weight, more preferably 0.0003 to 0.1 parts by weight, and particularly preferably 0.001 to 0.05 parts by weight, based on 100 parts by weight of the polymerizable component. When the amount of the water-soluble compound is too small, the effect of the water-soluble compound may not be sufficiently obtained. When the amount of the water-soluble compound is too large, the polymerization rate may decrease, or the residual amount of the polymerizable component as a raw material may increase.

The aqueous dispersion medium may contain a dispersion stabilizer and a dispersion stability auxiliary in addition to the electrolyte and the water-soluble compound.

Examples of the dispersion stabilizer include tricalcium phosphate, magnesium pyrophosphate obtained by a double decomposition production method, calcium pyrophosphate, colloidal silica, alumina sol, and magnesium hydroxide. These dispersion stabilizers may be used alone or in combination of two or more thereof.

The amount of the dispersion stabilizer is preferably 0.05 to 30 parts by weight, and more preferably 0.2 to 20 parts by weight, based on 100 parts by weight of the polymerizable component.

The dispersion stability auxiliary is not particularly limited, and examples of the dispersion stability auxiliary include surfactants such as a polymer-type dispersion stability auxiliary, a cationic surfactant, an anionic surfactant, an amphoteric ionic surfactant, and a nonionic surfactant. These dispersion stability auxiliaries may be used alone or in combination of two or more thereof.

The aqueous dispersion medium is prepared, for example, by blending a water-soluble compound together with, as necessary, a dispersion stabilizer, a dispersion stability auxiliary, and the like in water (deionized water). The pH of the aqueous dispersion medium in the polymerization is appropriately determined depending on the types of the water-soluble compound, the dispersion stabilizer, and the dispersion stability auxiliary.

In the method for producing the heat-expandable microspheres of the present invention, the polymerization may be performed in the presence of sodium hydroxide and/or zinc chloride.

In the method for producing the heat-expandable microspheres of the present invention, it is preferable to suspend and disperse the oily mixture in the aqueous dispersion medium to be formed into spherical oil droplets having a predetermined particle size.

In the polymerization step, a chain transfer agent, organic pigments, inorganic pigments or inorganic particles having a hydrophobically treated surface, or the like may be further used.

In the polymerization step, the oily mixture is suspended and dispersed in the aqueous dispersion medium to be formed into spherical oil droplets having a predetermined particle size.

Examples of the method for suspending and dispersing the oily mixture include general dispersion methods such as a method of stirring with a homomixer (for example, manufactured by PRIMIX Corporation) or the like, a method using a static dispersion apparatus such as a static mixer (for example, manufactured by NORITAKE CO., LIMITED), a membrane emulsification method, and an ultrasonic dispersion method.

Next, the suspension polymerization is started by heating the aqueous suspension in which the oily mixture is dispersed in the aqueous dispersion medium as spherical oil droplets. During the polymerization reaction, the aqueous suspension is preferably slowly stirred, for example, to such an extent that floating of monomer components and sedimentation of the polymerized heat-expandable microspheres can be prevented.

The polymerization temperature is freely set depending on the type of polymerization initiator, and is preferably controlled in the range of 30 to 100° C., more preferably 40 to 90° C. The time for holding the reaction temperature is preferably about 0.1 to 20 hours. The initial pressure for polymerization is not particularly limited, but is 0 to 5.0 MPa and more preferably 0.1 to 3.0 MPa in gauge pressure.

The resulting slurry can be filtered by a centrifuge, a press filter, a suction extractor, or the like to obtain a wet powder having a moisture content of 10 to 50 wt %, preferably 15 to 45 wt %, more preferably 20 to 40 wt %. In addition, the resulting wet powder is dried by a tray dryer, an indirect heating oven, a fluidized bed dryer, a vacuum dryer, a vibration dryer, a flash dryer, or the like to obtain a dry powder. The moisture content of the resulting dry powder is preferably less than or equal to 8 wt %, and more preferably less than or equal to 5 wt %. The resulting wet powder or the resulting dry powder may be washed with water and/or dispersed again and then filtered again, and dried for the purpose of reducing the content of the ionic substance. The slurry may be dried by a spray dryer, a fluidized bed dryer, or the like to obtain a dry powder. The wet powder and the dry powder can be appropriately selected according to the intended use.

### [Hollow Particles]

Hollow particles of the present invention are particles obtained by thermally expanding the heat-expandable microspheres described above. In addition, the hollow particles of the present invention are lightweight, and are excellent in material physical properties when contained in a composition or a molded article.

The hollow particles of the present invention are obtained by thermally expanding the heat-expandable microspheres described above, preferably at 80 to 450° C. The thermal expansion method is not particularly limited, and may be any of a dry thermal expansion method, a wet thermal expansion method, and the like. Examples of the dry thermal expansion method include a method described in JP 2006-213930 A, the content of which is incorporated herein by reference, particularly an internal injection method. As another dry thermal expansion method, there is a method described in JP 2006-96963 A, the content of which is incorporated herein by reference. Examples of the wet thermal expansion method include a method described in JP 62-201231 A, the content of which is incorporated herein by reference.

The mean particle size of the hollow particles of the present invention is not particularly limited, but can be freely designed according to the application, and is preferably 3 to 1000 μm, more preferably 10 to 500 μm, still more preferably 15 to 300 μm, and particularly preferably 30 to 300 μm.

The coefficient CV of variation of the particle size distribution of the hollow particles of the present invention is not particularly limited, but is preferably less than or equal to 50%, more preferably less than or equal to 40%, still more preferably less than or equal to 35%, and particularly preferably less than or equal to 30%.

The true specific gravity of the hollow particles of the present invention is not particularly limited, but is preferably 0.001 to 0.60, more preferably 0.002 to 0.50, still more preferably 0.003 to 0.40, particularly preferably 0.004 to 0.30, and most preferably 0.005 to 0.20 from the viewpoint of achieving the effects of the present application.

### [Fine-Particle-Coated Hollow Particles]

Fine-particle-coated hollow particles of the present invention include the hollow particles described above and fine particles coating an outer surface of a shell portion of the hollow particles. For example, the fine-particle-coated hollow particles are formed of fine particles (4 and 5) coating an outer surface of a shell portion (2) of hollow particles (1) as illustrated in FIG. 2.

The term “coating” as used herein means that the fine particles 4 and 5 may be simply absorbed on the outer surface of the shell 2 of the hollow particles (the state of the fine particles 4 in FIG. 2), or the thermoplastic resin constituting the shell in the vicinity of the outer surface may be melted by heating, and the fine particles may be embedded and fixed on the outer surface of the shell of the hollow particles (the state of the fine particles 5 in FIG. 2). The particle shape of the fine particles may be irregular or spherical.

The fine particles coating the hollow particles prevent scattering of the hollow particles to improve handling and dispersibility in a base material component such as a binder or a resin.

As the fine particles, various materials can be used, and any material of an inorganic substance and an organic substance may be used. Examples of the shape of the fine particles include a spherical shape, a needle shape, and a plate shape.

The inorganic substance constituting the fine particles is not particularly limited, and examples of the inorganic substance include wollastonite, sericite, kaolin, mica, clay, talc, bentonite, alumina silicate, pyrophyllite, montmorillonite, calcium silicate, calcium carbonate, magnesium carbonate, dolomite, calcium sulfate, barium sulfate, glass flakes, boron nitride, silicon carbide, silica, alumina, mica, titanium dioxide, zinc oxide, magnesium oxide, zinc oxide, hydrotalcite, carbon black, molybdenum disulfide, tungsten disulfide, ceramic beads, glass beads, quartz beads, and glass microballoons.

The organic substance constituting the fine particles is not particularly limited, and examples of the organic substance include sodium carboxymethyl cellulose, hydroxyethyl cellulose, methyl cellulose, ethyl cellulose, nitrocellulose, hydroxypropyl cellulose, sodium alginate, polyvinyl alcohol, polyvinylpyrrolidone, sodium polyacrylate, carboxyvinyl polymer, polyvinyl methyl ether, magnesium stearate, calcium stearate, zinc stearate, polyethylene wax, lauric acid amide, myristic acid amide, palmitic acid amide, stearic acid amide, cured castor oil, (meth)acrylic resin, polyamide resin, silicone resin, urethane resin, polyethylene resin, polypropylene resin, and fluorine-based resin.

The inorganic substance or organic substance constituting the fine particles may be treated with a surface treatment agent such as a silane coupling agent, a paraffin wax, a fatty acid, a resin acid, a urethane compound, or a fatty acid ester, or may be untreated.

The mean particle size of the fine particles is not particularly limited, but is preferably 0.001 to 30 μm, more preferably 0.005 to 25 μm, and particularly preferably 0.01 to 20 μm. The mean particle size is a value of the volume-based cumulative 50% particle size measured by laser diffractometry.

The ratio of the mean particle size of the fine particles to the mean particle size of the hollow particles (the mean particle size of fine particles/the mean particle size of hollow particles) is not particularly limited, but is preferably less than or equal to 1, more preferably less than or equal to 0.1, and still more preferably less than or equal to 0.05 from the viewpoint of the coating of the fine particles onto the surfaces of the hollow particles.

The weight ratio of the fine particles to the entire fine-particle-coated hollow particles is not particularly limited, but is preferably 10 to 95 wt %, more preferably 20 to 90 wt % or less, still more preferably 30 to 85 wt %, and particularly preferably 40 to 80 wt %. When the weight ratio is within the above-described range, the effect of the coating of the fine particles tends to be improved.

The true specific gravity of the fine-particle-coated hollow particles is not particularly limited, but is preferably 0.01 to 0.60, more preferably 0.03 to 0.40, still more preferably 0.05 to 0.30, and particularly preferably 0.07 to 0.20.

The fine-particle-coated hollow particles of the present invention can be obtained, for example, by thermally expanding fine-particle-coated heat-expandable microspheres. As the method for producing the fine-particle-coated hollow particles, a production method including a step (mixing step) of mixing the heat-expandable microspheres and the fine particles, and a step (coating step) of heating the mixture obtained in the mixing step to a temperature higher than the softening point to expand the heat-expandable microspheres and coat the outer surfaces of the obtained hollow particles with the fine particles is preferable.

The mixing step is a step of mixing the heat-expandable microspheres and the fine particles.

The weight ratio of the fine particles to the total of the heat-expandable microspheres and the fine particles in the mixing step is not particularly limited, but is preferably 10 to 95 wt %, more preferably 20 to 90 wt %, still more preferably 30 to 85 wt %, and particularly preferably 40 to 80 wt %.

In the mixing step, an apparatus used for mixing the heat-expandable microspheres and the fine particles is not particularly limited, and the mixing can be performed using an apparatus having an extremely simple mechanism such as a container and a stirring blade. A powder mixer that can perform general shaking or stirring may also be used.

Examples of the powder mixer include powder mixers that can perform shaking or stirring, such as a ribbon mixer or a vertical screw mixer. More efficient multifunctional powder mixers combined with a stirring apparatus, such as Super Mixer (manufactured by KAWATA MFG. CO., LTD.), High Speed Mixer (manufactured by Fukae Co., Ltd.), New-Gram Machine (manufactured by Seishin Enterprise Co., Ltd.), and SV Mixer (manufactured by Kobelco Eco-solutions Co., Ltd.), may be used.

The coating step is a step of heating the mixture containing the heat-expandable microspheres and the fine particles obtained in the mixing step to a temperature higher than the softening point of the thermoplastic resin constituting the shell of the heat-expandable microspheres. In the coating step, the heat-expandable microspheres are expanded, and the outer surface of the shell portion of the obtained hollow particles is coated with the fine particles.

The heating step may be performed using a common contact heat-transfer type or direct heating type mixer dryer. The function of the mixer dryer is not particularly limited, but the mixer dryer preferably has a function of dispersing and mixing raw materials under a controlled temperature, and optionally includes a decompression device for accelerating drying or a cooling device. The device used for heating is not particularly limited, and examples of the device include Loedige Mixer (manufactured by MATSUBO Corporation) and Solidaire (manufactured by Hosokawa Micron Corporation).

The temperature condition of heating depends on the type of the heat-expandable microspheres, but it is preferable that the temperature be around the maximum expansion temperature of the heat-expandable microspheres, and the temperature is preferably 70 to 250° C., more preferably 80 to 230° C., and still more preferably 90 to 220° C.

### [Composition and Molded Article]

A composition of the present invention contains at least one selected from the group consisting of the heat-expandable microspheres, the hollow particles, and the fine-particle-coated hollow particles described above, and a base material component.

The base material component is not particularly limited, and examples of the base material compound include rubbers such as natural rubber, butyl rubber, silicone rubber, and ethylene-propylene-diene monomer rubber (EPDM); thermosetting resins such as unsaturated polyester, epoxy resin, and phenol resin; waxes such as polyethylene wax and paraffin wax; thermoplastic resins such as ethylene-vinyl acetate copolymer (EVA), ionomer, polyethylene, polypropylene, polyvinyl chloride (PVC), acrylic resin, thermoplastic polyurethane, acrylonitrile-styrene copolymer (AS resin), acrylonitrile-butadiene-styrene copolymer (ABS resin), polystyrene (PS), polyamide resin (nylon 6, nylon 66, and the like), polycarbonate, polyethylene terephthalate (PET), polybutylene terephthalate (PBT), polyacetal (POM), and polyphenylene sulfide (PPS); thermoplastic elastomers such as olefin-based elastomers and styrene-based elastomers; fluorine-containing resins such as polyvinylidene fluoride, polytetrafluoroethylene, vinylidene fluoride-hexafluoropropylene-tetrafluoroethylene copolymer, vinylidene fluoride-hexafluoropropylene copolymer, vinylidene fluoride-tetrafluoroethylene copolymer, hexafluoropropylene-tetrafluoroethylene copolymer, and ethylene-tetrafluoroethylene; bioplastics such as polylactic acid (PLA), cellulose acetate, polybutylene succinate (PBS), polyhydroxyalkanoates (PHA), and starch resin; sealing materials such as silicone-based, modified silicone-based, polysulfide-based, modified polysulfide-based, urethane-based, acryl-based, polyisobutylene-based, and butyl rubber-based sealing materials; liquid components such as urethane-based, ethylene-vinyl acetate copolymer-based, vinyl chloride-based, and acryl-based emulsions and plastisols; inorganic substances such as cement, mortar, and cordierite; and organic fibers such as cellulose, kenaf, bran, aramid fibers, phenol fibers, polyester-based fibers, acrylic fibers, polyolefin-based fibers such as polyethylene fibers and polypropylene fibers, polyvinyl alcohol-based fibers, and rayon, and one kind or two or more kinds thereof may be used in combination.

The composition of the present invention can be prepared by mixing at least one selected from the group consisting of the heat-expandable microspheres, the hollow particles, and the fine-particle-coated hollow particles with a base material component. The composition of the present invention can also be prepared by further mixing another base material component with the composition obtained by mixing at least one selected from the group consisting of the heat-expandable microspheres, the hollow particles, and the fine-particle-coated hollow particles with the base material component.

The composition of the present invention may also contain at least one selected from the group consisting of the heat-expandable microspheres, the hollow particles, and the fine-particle-coated hollow particles, and other components depending on the application in addition to the base material component. Examples of the other components include a plasticizer, a filler, a colorant, a high-boiling-point organic solvent, and an adhesive.

In the composition of the present invention, the total content of the heat-expandable microspheres, the hollow particles, and the fine-particle-coated hollow particles is not particularly limited, but is preferably 0.05 to 750 parts by weight based on 100 parts by weight of the base material component. When the total content is greater than or equal to 0.05 parts by weight, a sufficiently lightweight molded article tends to be obtained. On the other hand, when the total content is less than or equal to 750 parts by weight, the uniform dispersibility of at least one selected from the group consisting of the heat-expandable microspheres, the hollow particles, and the fine-particle-coated hollow particles tends to be further improved. The upper limit of the total content is more preferably 700 parts by weight, still more preferably 650 parts by weight, particularly preferably 600 parts by weight, and most preferably 500 parts by weight. On the other hand, the lower limit of the total content is more preferably 0.1 parts by weight, still more preferably 0.2 parts by weight, particularly preferably 0.5 parts by weight, and most preferably 1 part by weight. The total content is, for example, preferably 0.1 to 700 parts by weight, and more preferably 0.5 to 600 parts by weight.

A method for preparing the composition of the present invention is not particularly limited, and conventionally known methods may be employed. Examples of the method include a method of mechanically uniformly mixing using a mixer such as a homomixer, a static mixer, a Henschel mixer, a tumbler mixer, a planetary mixer, a kneader, a roll, a mixing roll, a mixer, a single screw kneader, a twin screw kneader, or a multi-screw kneader.

Examples of the composition of the present invention include a rubber composition, a molding composition, a coating composition, a clay composition, an adhesive composition, and a powder composition.

A molded article of the present invention is obtained by molding the composition described above.

Examples of the molded article of the present invention include molded articles and coating films.

In the molded article of the present invention, various physical properties such as lightweight, porosity, sound absorption, heat insulation, low thermal conductivity, low dielectric constant, designability, impact absorption, and strength are improved, and an effect of excellent appearance can also be obtained.

### EXAMPLES

Examples of the heat-expandable microspheres of the present invention will be specifically described below. Note that the present invention is not limited to these Examples. In the following Examples and Comparative Examples, unless otherwise specified, “%” means “wt %”, and “parts” means “parts by weight”.

In addition, the physical properties of the heat-expandable microspheres described in the following Examples and Comparative Examples were measured in the following manner, and the performance was further evaluated. Hereinafter, the heat-expandable microspheres may be referred to as “microspheres” for the sake of simplicity.

### [Measurement of Mean Particle Size (D50) and Particle Size Distribution of Heat-Expandable Microspheres]

As a measuring instrument, a Microtrac particle size distribution analyzer (model: 9320-HRA) manufactured by Nikkiso Co., Ltd. was used, and a D50 value obtained by volume-based measurement was defined as a mean particle size.

### [Measurement of Expansion-Starting Temperature (Ts) and Maximum Expansion Temperature (Tmax) of Heat-Expandable Microspheres]

DMA (DMA Q800 type, manufactured by TA instruments) was used as a measuring instrument. 0.5 mg of heat-expandable microspheres were placed in an aluminum cup having a diameter of 5.6 mm and a depth of 4.8 mm, and an aluminum lid (diameter 5.6 mm, thickness 0.1 mm) was placed on a heat-expandable microsphere layer to prepare a sample. The height of the sample was measured while applying a force of 0.01 N to the sample from above with a compression unit. The sample was heated from 20° C. to 350° C. at a temperature rising rate of 10° C./min while applying a force of 0.01 N with the compression unit, and a change in the position of the compression unit in the vertical direction was measured. The temperature at which the position of the compression unit started to change to the positive direction was defined as an expansion-starting temperature (Ts), and the temperature at which the change in the position of the compression unit indicated the maximum (Hmax) was defined as a maximum expansion temperature (Tmax).

### [Measurement of Moisture Content (C_{w1}) of Heat-Expandable Microspheres]

Measurement was performed using a Karl Fischer moisture meter (MKA-510N, manufactured by Kyoto Electronics Manufacturing Co., Ltd.) as a measuring instrument. The moisture content (wt %) of the heat-expandable microspheres was defined as C_{w1}.

[Measurement of Encapsulation Ratio (C₁) of blowing agent of heat-Expandable microspheres]

1.0 g of heat-expandable microspheres were placed in a stainless steel evaporating dish having a diameter of 80 mm and a depth of 15 mm, and the weight (W₁ (g)) thereof was measured. Then, 30 ml of acetonitrile was added to disperse the microspheres uniformly, the resulting dispersion was allowed to stand at room temperature for 24 hours, and then dried under reduced pressure at 130° C. for 2 hours, and the weight (W₂ (g)) of the resultant was measured.

The encapsulation ratio (C₁) of the blowing agent of the heat-expandable microspheres was calculated by the following formula.

$${C}_{1} ( wt \% ) = 100 \times \{ 100 \times ( {W}_{1} - {W}_{2} ) / 1.0 - {C}_{w 1} \} / ( 1 \; 00 - {C}_{w 1} )$$

where the moisture content C_{w1} of the heat-expandable microspheres was the value measured by the above-described method.

### [Measurement of Weight Ratio of Hydrocarbon Having 5 to 6 Carbon Atoms]

The weight ratio of the hydrocarbon having 5 to 6 carbon atoms to the blowing agent in the heat-expandable microspheres was measured by a gas chromatography head space method as follows.

About 0.05 g of heat-expandable microspheres were weighed in a vial bottle, about 1 g of N, N-dimethylformamide was added to the vial bottle, and the vial bottle was quickly sealed. Then, the sealed vial was incubated at 140° C. for 1 hour, and then the gas phase (head space) was collected with a gas-tight syringe, and introduced into a GC (GC column: Rxi-62Sil MS (length: 30 m, inner diameter: 0.32 mm, film thickness: 1.8 μm) manufactured by Restek Corporation) to measure the weight ratio of the hydrocarbon having 5 to 6 carbon atoms to the blowing agent. As a standard sample, normal hexane was employed.

### [Measurement of True Specific Gravity]

The true specific gravity of the heat-expandable microspheres, the hollow particles, or the fine-particle-coated hollow particles (hereinafter, may be simply referred to as sample particles in general) was measured by the following measurement method.

The true specific gravity was measured by a liquid immersion method (Archimedes method) using isopropyl alcohol under an atmosphere of an environmental temperature of 25° C. and a relative humidity of 50%. Specifically, a 100-mL measuring flask was emptied and dried, and then the weight (WB1) of the measuring flask was weighed. The weighed measuring flask was filled with isopropyl alcohol accurately to form meniscus, and then the weight (WB2) of the measuring flask filled with 100 mL of isopropyl alcohol was weighed. The 100-mL measuring flask was emptied and dried, and then the weight (WS1) of the measuring flask was weighed. The weighed measuring flask was filled with about 50 mL of sample particles, and the weight (WS2) of the measuring flask filled with the sample particles was weighed. Then, isopropyl alcohol was poured into the measuring flask filled with the sample particles accurately to form meniscus so that bubbles did not enter, and then the weight (WS3) of the measuring flask filled with the particles and isopropyl alcohol was weighed. Then, the obtained WB1, WB2, WS1, WS2, and WS3 were introduced into the following formula to calculate the true specific gravity (d) of the sample particles.

$$d = \{ ( WS 2 - WS 1 ) \times ( WB 2 - WB 1 ) / 100 \} / \{ WB 2 - WB 1 ) - ( WS 3 - WS 2 ) \}$$

[Method for Producing Treated Article Heated at Temperature Lower than Tmax by 20° C.]

A flat box having a bottom surface with a length of 12 cm, a width of 13 cm, and a height of 9 cm was prepared with an aluminum foil, and 1.0 g of dried microspheres were uniformly placed in the box. The box was placed in a gear-type oven and the microspheres were thermally expanded at a temperature lower by 20° C. than the maximum expansion temperature (Tmax) obtained by the above-described method for 2 minutes to prepare a heat-treated article.

### [Measurement of Recovery Efficiency]

An aluminum cup having an inner diameter of 5.65 mm and a depth of 4.8 mm was placed so as to be filled with the treated article thermally expanded for 2 minutes at the temperature lower by 20° C. than the maximum expansion temperature obtained by the method described above, and an aluminum lid having a diameter of 5.6 mm and a thickness of 0.1 mm was placed on the top of the layer of the heat-treated article to prepare a sample.

DMA (DMA Q800 type, manufactured by TA instruments) was used as a measuring apparatus, and the prepared sample was pressurized from 0 N to 18 N from the upper portion of the aluminum lid at a rate of 10 N/min by a compression unit in an atmosphere at 25° C., and then depressurized from 18 N to 0 N at a rate of 10 N/min.

Based on the obtained stress and the position of the compression unit (height of the layer of the heat-treated article), the stress at the time of applying a pressure of 18 N was defined as A1, and the position of the compression unit was defined as B1. Next, in the depressurization, the stress when the compression unit moved by 0.1 mm from the start of the depressurization was defined as A′1.

From the measured Al and A′1, the recovery efficiency after the compression of the treated article heated at the temperature lower by 20° C. than the maximum expansion temperature of the heat-expandable microspheres for 2 minutes was calculated by the following calculation formula (3). The calculated recovery efficiency is an absolute value.

$$( The recovery efficiency ) = \vert ( {A}^{′} 1 - A 1 ) / 0.1 \vert \qquad ( 3 )$$

### [Measurement of Compression Recovery Rate]

The operation performed in the measurement of the recovery efficiency was repeated five times. Based on the obtained position of the compression unit (height of the layer of the heat-treated article), the position of the compression unit in a state where a force of 2.5 N was applied when the upper portion of the aluminum lid was pressurized from 0 N to 18 N at a rate of 10 N/min when the operation was performed n times was defined as Ln (n=1 to 5). From the measured Ln, the compression recovery rate of the treated article obtained when heating was performed at the temperature lower by 20° C. than the maximum expansion temperature of the heat-expandable microspheres for 2 minutes was calculated by the following calculation formula (4). The higher the compression recovery rate, the more the deformation of the expanded product, which is the heat-treated article of the heat-expandable microspheres, is suppressed.

$$( The compression recovery rate ( \% ) ) = ( L 5 / L 1 ) \times 100 \qquad ( 4 )$$

### [Measurement of Specific Gravity of Molded Article]

The specific gravity of the resulting molded article was measured by an immersion method using a precision pycnometer AX200 (manufactured by Shimadzu Corporation).

### [Measurement of Compression Set of Molded Article]

The compression set (%) of the resulting molded article was measured under the conditions of 25° C., 22 hours, and 25% compression by a method in accordance with JIS K6262. The measured compression set was determined based on the following evaluation criteria, and B or greater was regarded as acceptable.
B: The compression set is less than or equal to 50%, and deformation of the molded article is suppressed.
D: The compression set is greater than 50%, and the molded article is deformed.

### [Measurement of Flexural Strength of Molded Article]

Regarding the obtained molded article, a test piece having a length of 80 mm×a width of 25 mm×a thickness of 2 mm cut out from the molded article was evaluated for 3-point bending flexibility by using an Instron universal testing machine (Instron) by a method in accordance with JIS K7171. The test piece was set on a jig having a pair of supports installed at an interval of 64 mm, and the flexural modulus (MPa) was measured while pushing the test piece from above at a speed of 1 mm/min at a position corresponding to the center between the supports. Furthermore, the flexural modulus of a base resin was also measured by the above-described method.

The flexural strength was calculated from the measured flexural modulus of the test piece and the flexural modulus of the base resin according to the following calculation formula (5), and the flexural strength was determined based on the following evaluation criteria, and B or greater was regarded as acceptable.

$$The flexural strength = the flexural modulus of the molded article / the elastic modulus of the base resin \qquad ( 5 )$$

A: The flexural strength is greater than or equal to 0.90, and deformation of the molded article is further suppressed.
B: The flexural strength is greater than or equal to 0.75 and less than 0.90, and deformation of the molded article is suppressed.
D: The flexural strength is less than 0.75, and the molded article is deformed.

It is to be noted that since the compression set of the molded article was B and the flexural strength of the molded article was A or B, the molded article that was hardly deformed for a long period of time was obtained.

### [Measurement of Yellowing Degree of Molded Article]

For the obtained molded article, the b* value of the molded article was measured using a color difference meter (manufactured by Konica Minolta, Inc., CR-400). This b* value is a b* value in the L*a*b* color system, and the larger this value is, the more yellowed it is. The yellowing degree was evaluated based on the b* value of the measured molded article, and determined based on the following evaluation criteria, and B or greater was regarded as acceptable.
A: The yellowing degree is less than 3.0, and the yellowing of the molded article can be suppressed.
B: The yellowing degree is greater than or equal to 3.0 and less than 10.0, and the yellowing of the molded article can be slightly suppressed.
D: The yellowing degree is greater than or equal to 10.0, and the yellowing of the molded article cannot be suppressed.

### Production of Heat-Expandable Microspheres

### Preparation Example 1

170 parts of sodium chloride was dissolved in 680 parts of deionized water, and 1.0 parts of polyvinylpyrrolidone, 0.05 parts of carboxymethylated polyimine Na salt, and 55 parts of colloidal silica (effective concentration: 20%) were added thereto to adjust the pH to 3.0 so as to prepare an aqueous dispersion medium.

Separately, 2 parts of acrylonitrile, 65 parts of methacrylic acid, 20 parts of methacrylamide, 10 parts of styrene, 160 parts of methacrylonitrile, 1 part of PEG #200 diacrylate, 7 parts of di-2-ethylhexyl peroxydicarbonate (purity: 70%), and 65 parts of 2-methylbutane (isopentane) were mixed to prepare an oily mixture.

The aqueous dispersion medium and the oily mixture were mixed, and the resulting mixture liquid was dispersed by a homomixer (TK Homomixer manufactured by PRIMIX

Corporation) at a rotation speed of 10,000 rpm for 1 minute to prepare an aqueous suspension.

The obtained aqueous suspension was transferred to a 1.5-liter compressive reactor, the reactor was purged with nitrogen, and the suspension was subjected to a polymerization reaction at a polymerization temperature of 60° C. for 20 hours with stirring at 80 rpm under an initial reaction pressure of 0.35 MPa. After the polymerization, the produced article was filtered and dried to obtain heat-expandable microspheres A. The physical properties of the obtained heat-expandable microspheres were measured and evaluated. The results are shown in Table 1.

### Preparation Examples 2 to 9, Comparative Preparation Examples 1 to 8

In Preparation Examples 2 to 9 and Comparative Preparation Examples 1 to 8, heat-expandable microspheres B to P were obtained in the same manner as in Preparation Example 1 except that changes were made as shown in Tables 1 and 2. However, in Comparative Preparation Example 3, heat-expandable microspheres were not obtained.

The physical properties of the obtained heat-expandable microspheres were measured and evaluated in the same manner as in Preparation Example 1. The results are shown in Tables 1 and 2.

In Tables 1 and 2, the following abbreviations are used.
1.9ND-A: 1,9-nonanediol diacrylate
4EG-A: PEG #200 diacrylate

### Production of Molded Article

### Example 1

A resin composition in which 970 parts by weight of an olefinic elastomer (Milastomer 8032NS manufactured by Mitsui Chemicals, Inc., compression set (23° C./22 hours): 30%, elastic modulus: 60 MPa, specific gravity: 0.88) and 30 parts by weight of the microspheres A obtained in Example 1 were uniformly mixed was supplied to a hopper of an injection molding machine (J85AD-110H manufactured by The Japan Steel Works, Ltd., mold clamping force: 85 tons), melt-kneaded, and injected into a mold by a short shot method to obtain a plate-shaped molded article. The molding conditions were set such that the molding temperature was the maximum expansion temperature (Tmax) of the microspheres A, the injection filling time was 1 second, the injection speed was 200 mm/sec, the surface temperature of the mold was 30° C., and the thickness of the molded article was 7.0 mm. The physical properties of the obtained molded article were measured and evaluated. The results are shown in Table 1.

### Examples 2 to 9, Comparative Examples 1 to 8

In each of Examples 2 to 9 and Comparative Examples 1 to 8, injection molding was performed under the same conditions as in Example 1 to obtain a plate-shaped molded article. The physical properties of the obtained molded article were measured and evaluated. The results are shown in Tables 1 and 2. The molding temperature was the maximum expansion temperature of the heat-expandable microspheres.

TABLE 1

| | | Example | | | | |
|---|---|---|---|---|---|---|
| | | 1 | 2 | 3 | 4 | 5 |
| Heat-expandable microspheres | | A | B | C | D | E |
| Polymerizable | Acrylonitrile | 2 | 5 | 5 | 10 | 30 |
| component | Methacrylic acid | 65 | 50 | 120 | 75 | 40 |
| (parts by | Acrylic acid | | | 75 | | |
| weight) | Methyl methacrylate | | | | | |
| | Methacrylamide | 20 | 15 | 20 | 30 | 20 |
| | N-tert- | | | | | |
| | butylacrylamide | | | | | |
| | Styrene | 10 | 20 | 20 | 20 | 20 |
| | Methacrylonitrile | 160 | 170 | 20 | 120 | 145 |
| | Vinylidene chloride | | | | | |
| | 1,9ND-A | | 0.6 | | | 1.1 |
| | 4EG-A | 1.1 | 0.6 | 1.1 | 1.1 | |
| Blowing agent | Isobutane | | 13 | | | |
| (parts by | Isopentane | 65 | 52 | 50 | 58 | |
| weight) | Normal pentane | | | | | |
| | Isohexane | | | | | 65 |
| | Isooctane | | | | 7 | |
| | Isodecane | | | 20 | | |
| | Isododecane | | | | | |
| Content of blowing agent (wt %) | | 18 | 18 | 19 | 18 | 19 |
| Weight ratio (wt %) of hydrocarbon | | 100 | 80.5 | 71 | 88 | 100 |
| having 5 to 6 carbon atoms to | | | | | | |
| blowing agent | | | | | | |
| Evaluation of | Mean particle size | 30 | 28 | 20 | 20 | 25 |
| heat- | (μm) | | | | | |
| expandable | Expansion-starting | 150 | 145 | 185 | 160 | 140 |
| microspheres | temperature (° C.) | | | | | |
| | Maximum expansion | 200 | 190 | 240 | 220 | 180 |
| | temperature (° C.) | | | | | |
| | Specific gravity of | 1.0 | 1.0 | 1.1 | 1.1 | 1.0 |
| | microspheres | | | | | |
| | Specific gravity of | 0.019 | 0.025 | 0.039 | 0.032 | 0.022 |
| | treated article | | | | | |
| | Recovery efficiency | 1.8 | 2.7 | 3.4 | 2.6 | 2.0 |
| | (MPa/mm) | | | | | |
| | Compression recovery | 78 | 71 | 68 | 75 | 85 |
| | rate (%) | | | | | |
| Evaluation of | Specific gravity | 0.408 | 0.463 | 0.554 | 0.514 | 0.437 |
| molded article | of molded article | | | | | |
| | Compression set (%) | 41.9 | 47.3 | 48.1 | 44.8 | 38.1 |
| | Compression set | B | B | B | B | B |
| | Flexural modulus | 58 | 54 | 48 | 55 | 57 |
| | (MPa) | | | | | |
| | Flexural strength | A | A | B | A | A |
| | Suppression of | A | A | A | B | B |
| | yellowing | | | | | |

| | | Example | | | |
|---|---|---|---|---|---|
| | | 6 | 7 | 8 | 9 |
| Heat-expandable microspheres | | F | G | H | I |
| Polymerizable | Acrylonitrile | | | | |
| component | Methacrylic acid | 60 | 5 | 80 | 75 |
| (parts by | Acrylic acid | 70 | 75 | 50 | 85 |
| weight) | Methyl methacrylate | 75 | 175 | 125 | 90 |
| | Methacrylamide | | | | |
| | N-tert- | | | | |
| | butylacrylamide | | | | |
| | Styrene | | | | |
| | Methacrylonitrile | 45 | | | |
| | Vinylidene chloride | | | | |
| | 1,9ND-A | | | | 0.4 |
| | 4EG-A | 0.4 | 0.4 | 0.6 | |
| Blowing agent | Isobutane | | | | |
| (parts by | Isopentane | 35 | 50 | | 70 |
| weight) | Normal pentane | 32 | | 62 | |
| | Isohexane | | 20 | | |
| | Isooctane | 3 | 5 | 18 | |
| | Isodecane | | | | |
| | Isododecane | | | | |
| Content of blowing agent (wt %) | | 20 | 21 | 22 | 20 |
| Weight ratio (wt %) of hydrocarbon | | 94 | 92 | 76 | 100 |
| having 5 to 6 carbon atoms to | | | | | |
| blowing agent | | | | | |
| Evaluation of | Mean particle size | 23 | 18 | 22 | 32 |
| heat- | (μm) | | | | |
| expandable | Expansion-starting | 150 | 130 | 150 | 165 |
| microspheres | temperature (° C.) | | | | |
| | Maximum expansion | 190 | 175 | 195 | 200 |
| | temperature (° C.) | | | | |
| | Specific gravity of | 1.0 | 1.0 | 1.1 | 1.0 |
| | microspheres | | | | |
| | Specific gravity of | 0.028 | 0.035 | 0.029 | 0.024 |
| | treated article | | | | |
| | Recovery efficiency | 2.4 | 2.4 | 3.1 | 2.1 |
| | (MPa/mm) | | | | |
| | Compression recovery | 77 | 76 | 74 | 82 |
| | rate (%) | | | | |
| Evaluation of | Specific gravity | 0.486 | 0.532 | 0.475 | 0.454 |
| molded article | of molded article | | | | |
| | Compression set (%) | 43.2 | 44.0 | 45.1 | 40.5 |
| | Compression set | B | B | B | B |
| | Flexural modulus | 56 | 55 | 50 | 58 |
| | (MPa) | | | | |
| | Flexural strength | A | A | B | A |
| | Suppression of | A | A | A | A |
| | yellowing | | | | |

TABLE 2

| | | Comparative example | | | |
|---|---|---|---|---|---|
| | | 1 | 2 | 3 | 4 |
| Heat-expandable microspheres | | J | K | | L |
| Polymerizable | Acrylonitrile | 55 | | | 4 |
| component | Methacrylic acid | 45 | 23 | 130 | 179 |
| (parts by | Acrylic acid | | | 80 | |
| weight) | Methyl methacrylate | 155 | 23 | 40 | |
| | Methacrylamide | | | | |
| | N-tert- | | 12 | | |
| | butylacrylamide | | | | |
| | Styrene | | | | 21 |
| | Methacrylonitrile | | 140 | | 51 |
| | Vinylidene chloride | | 58 | | |
| | 1,9ND-A | | | 0.4 | |
| | 4EG-A | 0.4 | 0.4 | | 0.3 |
| Blowing agent | Isobutane | | | | |
| (parts by | Isopentane | | 23 | | 49 |
| weight) | Normal pentane | | | | |
| | Isohexane | 55 | | 30 | |
| | Isooctane | | 2 | | 5 |
| | Isodecane | | | 20 | |
| | Isododecane | 20 | | 25 | 10 |
| Content of blowing agent (wt %) | | 21 | 8 | Not | 18 |
| Weight ratio (wt %) of hydrocarbon | | 72 | 90 | obtained | 75 |
| having 5 to 6 carbon atoms to | | | | | |
| blowing agent | | | | | |
| Evaluation of | Mean particle size | 22 | 26 | | 20 |
| heat- | (μm) | | | | |
| expandable | Expansion-starting | 125 | 150 | | 209 |
| microspheres | temperature (° C.) | | | | |
| | Maximum expansion | 160 | 210 | | 245 |
| | temperature (° C.) | | | | |
| | Specific gravity of | 1.0 | 1.1 | | 1.1 |
| | microspheres | | | | |
| | Specific gravity of | 0.035 | 0.115 | | 0.063 |
| | treated article | | | | |
| | Recovery efficiency | 4.0 | 4.5 | | 9.9 |
| | (MPa/mm) | | | | |
| | Compression recovery | 67 | 62 | | 55 |
| | rate (%) | | | | |
| Evaluation of | Specific gravity | 0.535 | 0.693 | | 0.647 |
| molded article | of molded article | | | | |
| | Compression set (%) | 48.4 | 57.0 | | 54.1 |
| | Compression set | B | D | | D |
| | Flexural modulus | 43 | 49 | | 39 |
| | (MPa) | | | | |
| | Flexural strength | D | B | | D |
| | Suppression of | D | D | | B |
| | yellowing | | | | |
| | | Comparative example | | | |
| | | 5 | 6 | 7 | 8 |
| Heat-expandable microspheres | | M | N | O | P |
| Polymerizable | Acrylonitrile | | | 150 | |
| component | Methacrylic acid | 59 | 20 | | 77 |
| (parts by | Acrylic acid | | 20 | | 26 |
| weight) | Methyl methacrylate | | 215 | 1.3 | 153 |
| | Methacrylamide | | | | |
| | N-tert- | | | | |
| | butylacrylamide | | | | |
| | Styrene | | | | |
| | Methacrylonitrile | 196 | | 105 | |
| | Vinylidene chloride | | | | |
| | 1,9ND-A | | 0.8 | 1 | |
| | 4EG-A | 0.4 | | | 1 |
| Blowing agent | Isobutane | | 51 | | |
| (parts by | Isopentane | | | 60 | 38 |
| weight) | Normal pentane | 76 | | | |
| | Isohexane | | | | |
| | Isooctane | | 38 | | 38 |
| | Isodecane | | | | |
| | Isododecane | | | | |
| Content of blowing agent (wt %) | | 21 | 24 | 17 | 22 |
| Weight ratio (wt %) of hydrocarbon | | 100 | 0 | 100 | 48 |
| having 5 to 6 carbon atoms to | | | | | |
| blowing agent | | | | | |
| Evaluation of | Mean particle size | 50 | 21 | 15 | 25 |
| heat- | (μm) | | | | |
| expandable | Expansion-starting | 130 | 112 | 125 | 150 |
| microspheres | temperature (° C.) | | | | |
| | Maximum expansion | 210 | 128 | 165 | 180 |
| | temperature (° C.) | | | | |
| | Specific gravity of | 1.0 | 1.1 | 1.0 | 1,1 |
| | microspheres | | | | |
| | Specific gravity of | 0.023 | 0.983 | 0.137 | 0.055 |
| | treated article | | | | |
| | Recovery efficiency | 2.7 | 37.0 | 7.4 | 5.5 |
| | (MPa/mm) | | | | |
| | Compression recovery | 59 | 97 | 53 | 60 |
| | rate (%) | | | | |
| Evaluation of | Specific gravity | 0.446 | 0.763 | 0.677 | 0.612 |
| molded article | of molded article | | | | |
| | Compression set (%) | 52.3 | 59.9 | 55.6 | 53.7 |
| | Compression set | D | D | D | D |
| | Flexural modulus | 48 | 37 | 40 | 41 |
| | (MPa) | | | | |
| | Flexural strength | B | D | D | D |
| | Suppression of | B | B | D | B |
| | yellowing | | | | |

In the heat-expandable microspheres of each of Examples 1 to 9, a thermoplastic resin constituting a shell was a polymer of a polymerizable component, the polymerizable component contained at least one selected from the group consisting of a carboxyl group-containing monomer, a (meth)acrylic acid ester-based monomer, a styrene-based monomer, and a (meth)acrylamide-based monomer, the recovery efficiency after compression when the heat-expandable microspheres were heated at a temperature lower by 20° C. than the maximum expansion temperature of the heat-expandable microspheres for 2 minutes was greater than 0 and less than or equal to 3.5, and the compression recovery rate when the heat-expandable microspheres were heated at a temperature lower by 20° C. than the maximum expansion temperature of the heat-expandable microspheres for 2 minutes was greater than or equal to 658. Therefore, it was possible to obtain a molded article that is hardly deformed for a long period of time. It is also confirmed that yellowing was reduced.

On the other hand, as can be seen from each of Comparative Examples, when the heat-expandable microspheres did not have the characteristics as described above, the deformation of the molded article obtained using the heat-expandable microspheres could not be suppressed for a long period of time.

### INDUSTRIAL APPLICABILITY

The heat-expandable microspheres of the present invention can be used as, for example, a material for weight reduction such as putty, paint, ink, sealing materials, mortar, paper clay, or ceramic, and can be used together with a base material component for molding such as injection molding, extrusion molding, or press molding to produce a molded article excellent in sound insulation, heat insulation, heat shielding, sound absorption, and the like.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1: Heat-expandable microspheres comprising:
a shell containing a thermoplastic resin; and
a blowing agent that is encapsulated in the shell and is vaporized by heating, wherein
the thermoplastic resin is a polymer of a polymerizable component containing at least one selected from the group consisting of a carboxyl group-containing monomer, a (meth)acrylic acid ester-based monomer, a styrene-based monomer, and a (meth)acrylamide-based monomer,
a recovery efficiency after compression when the heat-expandable microspheres are heated at a temperature lower by 20° C. than a maximum expansion temperature of the heat-expandable microspheres for 2 minutes is greater than 0 and less than or equal to 3.5, and
a compression recovery rate when the heat-expandable microspheres are heated at the temperature lower by 20° C. than the maximum expansion temperature of the heat-expandable microspheres for 2 minutes is greater than or equal to 65%.

2: The heat-expandable microspheres according to claim 1, wherein the polymerizable component contains the carboxyl group-containing monomer, and contains at least one selected from the group consisting of the (meth)acrylic acid ester-based monomer, the styrene-based monomer, and the (meth)acrylamide-based monomer.

3: The heat-expandable microspheres according to claim 2, wherein a weight ratio of the carboxyl group-containing monomer to the polymerizable component is 10 to 80 wt %, and a weight ratio of at least one selected from the group consisting of the (meth)acrylic acid ester-based monomer, the styrene-based monomer, and the (meth)acrylamide-based monomer to the polymerizable component is 10 to 77 wt %.

4: The heat-expandable microspheres according to claim 1, wherein the blowing agent contains greater than or equal to 70 wt % of a hydrocarbon having 5 to 6 carbon atoms.

5: The heat-expandable microspheres according to claim 1, wherein a weight ratio of acrylonitrile to the polymerizable component is less than or equal to 13 wt %.

6: Hollow particles that are an expanded product of the heat-expandable microspheres according to claim 1.

7: Fine-particle-coated hollow particles comprising:
the hollow particles according to claim 6; and
fine particles coating an outer surface of a shell portion of the hollow particles.

8: A composition comprising the heat-expandable microspheres according to claim 1, and a base material component.

9: A molded article obtained by molding the composition according to claim 8.

10: The heat-expandable microspheres according to claim 2, wherein the blowing agent contains greater than or equal to 70 wt % of a hydrocarbon having 5 to 6 carbon atoms.

11: The heat-expandable microspheres according to claim 3, wherein the blowing agent contains greater than or equal to 70 wt % of a hydrocarbon having 5 to 6 carbon atoms.

12: The heat-expandable microspheres according to claim 2, wherein a weight ratio of acrylonitrile to the polymerizable component is less than or equal to 13 wt %.

13: Hollow particles that are an expanded product of the heat-expandable microspheres according claim 2.

14: Fine-particle-coated hollow particles comprising:
the hollow particles according to claim 13; and
fine particles coating an outer surface of a shell portion of the hollow particles.

15: A composition comprising the hollow particles according to claim 6, and a base material component.

16: A composition comprising the fine-particle-coated hollow particles according to claim 7, and a base material component.

17: A molded article obtained by molding the composition according to claim 15.

18: A molded article obtained by molding the composition according to claim 16.

19: The heat-expandable microspheres according to claim 3, wherein a weight ratio of acrylonitrile to the polymerizable component is less than or equal to 13 wt %.

20: The heat-expandable microspheres according to claim 11, wherein a weight ratio of acrylonitrile to the polymerizable component is less than or equal to 13 wt %.
